(19) United States
(12) Patent Application Publication
(10) Pub. No.: US 2002/0173978 A1
(43) Pub. Date: Nov. 21, 2002

(54) Method and apparatus for scoring travel itineraries in a data processing system

(75) Inventors: Stephen J. Boies, Mahopac, NY (US); Samuel H. Dinkin, Austin, TX (US); David Perry Greene, Ossining, NY (US); William Grey, Millwood, NY (US); Paul Andrew Moskowitz, Yorktown Heights, NY (US); Isidore Rigoutsos, Astoria, NY (US); Philip Shi-lung Yu, Chappagua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/859,713

(22) Filed: May 17, 2001

(51) Int. Cl. G06F 17/60

(52) U.S. Cl. 705/1; 705/5

(57) ABSTRACT

A method and apparatus for generating an itinerary. User values assigned to a set of factors relating to travel from a first location to a second location are identified. These user values are compared to travel data for a route of travel from the first location to the second location to form a score.

### BACKGROUND OF THE INVENTION

1. Technical Field

The present invention relates generally to an improved data processing system in particular to a method and apparatus for processing schedules in a data processing system. Still more particularly, the present invention relates to a method and apparatus for establishing travel itineraries.

2. Description of Related Art

In making travel plans, a person will call or visit a travel agent and provide the travel agent with the desired origin and destination locations. In addition, the person may request a particular airline, a class of service, and whether connections are present. With this information, the travel agent at the travel agency may generate an itinerary for the person. Another system that is often used by travelers involves setting up travel plans through the Internet. A traveler may visit many different Web sites, providing systems for setting up travel plans. Some of these Web sites are run by the airlines themselves, while others are run by independent travel companies. A person may visit a Web site and input an origin and destination, as well as dates and times for travel. In response to this input, the person is provided with a list of one or more flights, which may be taken to fulfill the desired travel.

Travelers, even with these modern systems, are often frustrated with traveling even though they are able to select various factors such as the type of airplane, the type of service and travel times. The systems currently available do not take into account other factors, such as delays due to weather or congestion, and the possibility of canceled flights.

Therefore, it would be advantageous to have an improved method and apparatus for generating a travel itinerary.

### SUMMARY OF THE INVENTION

The present invention provides a method and apparatus for generating an itinerary. User values assigned to a set of factors relating to travel from a first location to a second location are identified. These user values are compared to travel data for a route of travel from the first location to the second location to form a score. By using feedback information from the traveler, associations between characteristics of the trip and user preferences may be used to better prioritize future travel plans.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram of components used in generating travel itineraries in accordance with the preferred embodiment of the present invention;

FIG. 5 is a diagram of a Web page in accordance with the preferred embodiment of the present invention;

FIG. 6 is a flowchart of a process for generating itineraries in accordance with the preferred embodiment of the present invention; and

FIG. 7 is a flowchart of a process used for generating and scoring itineraries in accordance with the preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. In particular, server 104 may provide travel itinerary generation and scoring services in accordance with a preferred embodiment of the present invention. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

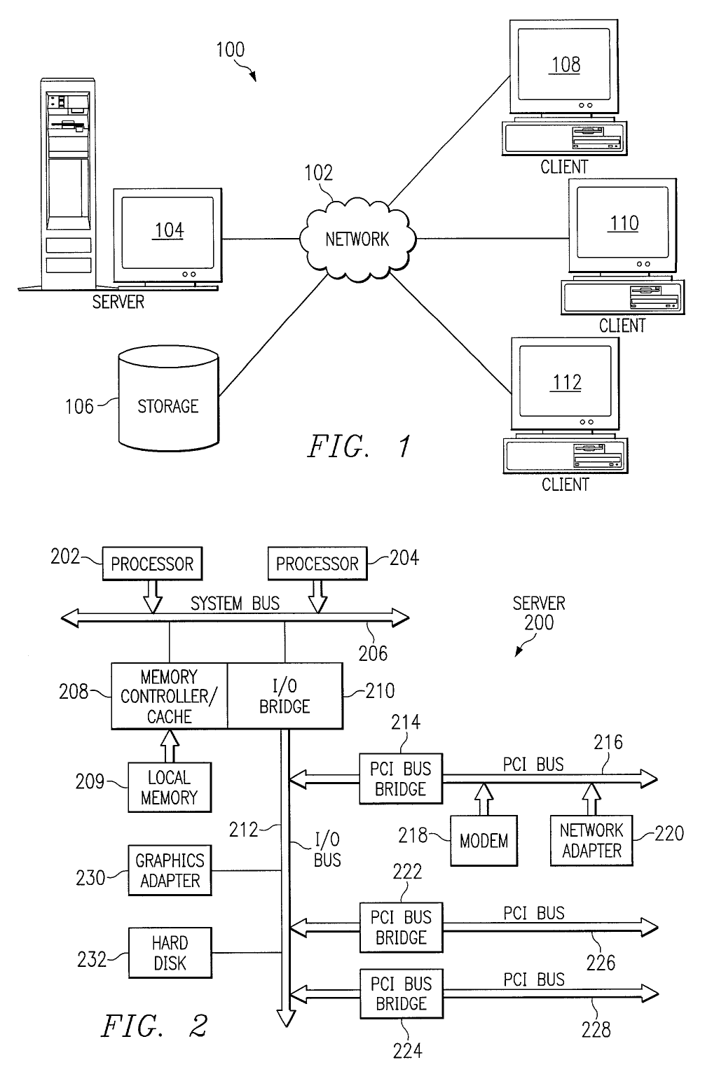

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 maybe integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 maybe provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

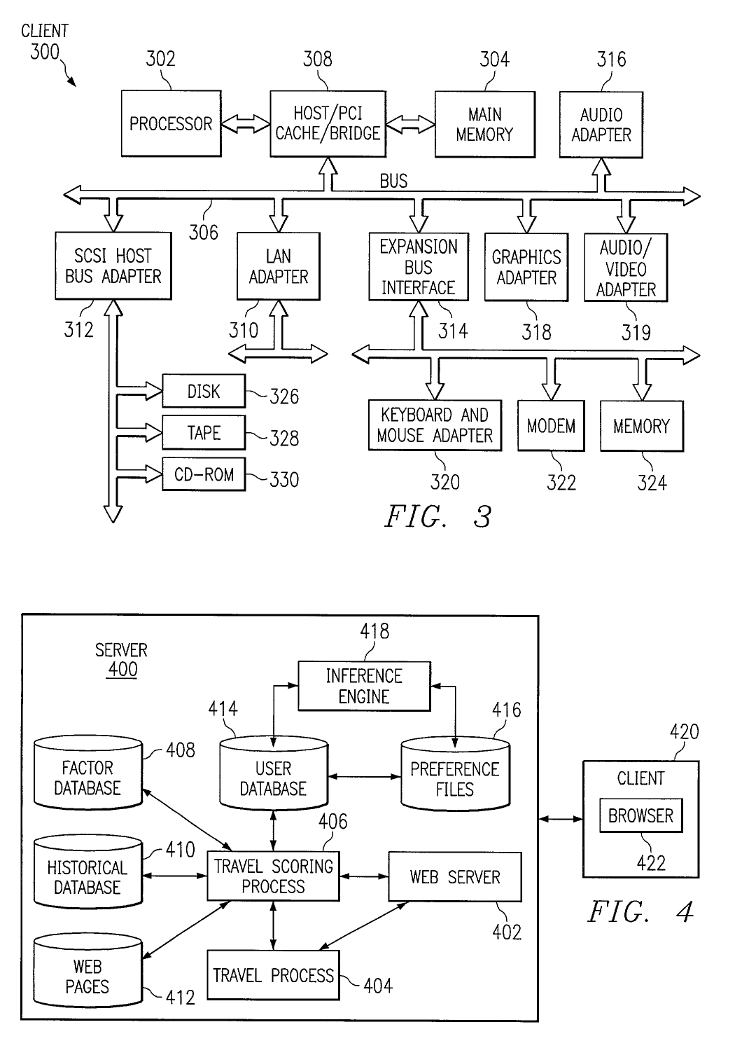

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention recognizes that a number of factors in generating travel itineraries are not accounted for by presently available systems. The present invention provides a method, apparatus, and computer implemented instructions for a travel scoring system used to set up travel itineraries. User values assigned to a set of factors relating to travel from a first location to a second location are identified. In these, examples, the factors may be obtained through a questionnaire in the form of a Web page sent to a user. The user may assign values for different factors or ignore factors entirely to reflect the importance of different factors to the user. These user values are compared to travel data for a route of travel from the first location to the second location to form a score. Further, the mechanism of the present invention does not require the user to make additional inquiries when making travel arrangements.

In such a system, a user may input values for various factors, such as, for example, travel time, waiting time, relative inconvenience of stops, plane changes, the cost of being late, the cost of being stuck en route, relative values of frequent flyer points, any bonus status information, seating preferences tradeoffs, expected wait time for baggage, and availability of special meals. The travel data in these examples includes data relating to factors present for difference routes or flights. This travel data may include historical data, such as, for example, delays occurring on similar days of the week, weather patterns corresponding to the date and/or season for the route or flight. The mechanism of the present invention scores different potential itineraries based on historic outcome arrivals adjusted for the day of week and season. In other words, the system takes into account peak and off-peak travel times as well as historical weather patterns.

Further, the mechanism of the present invention may measure the arrival time of one flight versus the departure time of another flight for travel itineraries requiring connections to assess the possibility of missed connections. Additionally, a check for back-up flight possibilities as well as frequent flyer information may be identified. The mechanism may tabulate average arrival time and anticipate whether the flight will be full. Other factors that may be taken into account include the cost, the probability of overnight delay due to cancellations, and whether overnight hotel will be paid by an airline in the case of being stranded. The mechanism also may take into account with respect to travel time for a particular day of travel the weather prediction for various hubs that may be originating or receiving a particular plane depending on the user input. Other factors such as the size of plane, the safety record of the plane, and the safety record of the airline may be taken into account. In this manner, the traveler may receive one or more itineraries based on a score generated by the input of values for different factors by the traveler. Further, this preference information may be used by the airlines to make changes or alter various amenities or routes to offer better service to travelers.

Turning now to FIG. 4, a block diagram of components used in generating travel itineraries is depicted in accordance with the preferred embodiment of the present invention. Server 400 may be implemented in a server, such as server 104 in FIG. 1 to provide travel scoring and travel itinerary generation using the mechanism of the present invention. Server 400 includes Web server 402, travel process 404, travel scoring process 406, factor database 408, historical database 410, and Web pages database 412.

Web server 402 serves to receive various requests from the Web and send those requests to the appropriate processes within server 400. Travel process 404 is a process used to set up and reserve flights for travelers. Travel process 404 may be implemented using currently available reservation systems for airline travel. Travel scoring process 406 implements the processes of the present invention used to select potential itineraries and score those potential itineraries based on user input. Factor database 408 contains factors, which may be assigned values by a user setting up a travel itinerary. Historical database 410 contains historical information relating to airline travel in these examples. For example, historical database 410 may contain information about weather during certain seasons and dates. Further, historical database 410 also may include information about delays and cancellations for different hubs and airports. Factor database 408 and historical database 410 may be implemented in a number of ways other than within server 400. For example, these two databases may be accessed through a search engine or other data repositories, such as those for mapping airports, airplane identification information, and other information relevant to travel. Web pages 412 is a database containing Web pages used to return information to a user as well as send Web pages requesting a user to assign values for factors, such as those found in factor database 408.

Additionally, user database 414 and preference files 416 are accessed by travel scoring process 406 to store information about users as well as preferences returned by users for various factors, such as those in factor database 408. Further, inference engine 418 uses pattern recognition methods to establish weights. Historical user data may be established using these preference weights rather than requiring the user to use default values or return a questionnaire. Further, similar user preferences may be analyzed in which these similar preferences are based on matching user characteristics and/or past travel behavior and ratings for other users having matching user characteristics or demographics.

In response to receiving a request from client 420 for a travel itinerary, Web server 402 will pass that request on to travel scoring process 406. In this example, the request is generated by browser 416 at client 414. Travel scoring process 406 will generate a Web page using Web pages 412. This initial Web page will query the user as to how the itinerary will be generated. This Web page includes a query as to whether the user desires to have the itinerary based on defaults or existing preferences, through filling out a questionnaire, by inferences made using historical data or preferences based on matching user characteristics for other users. If a questionnaire is desired, travel scoring process 406 will generate a second Web page and place factors from factor database 408 within this second Web page. These factors are ones that will be assigned values. This Web page is then returned to client 420 through Web server 402. The Web page is displayed within browser 422 to allow the user to input values for the different factors on the Web page returned from server 400.

After the user has input values, the Web page is then returned to server 400. Web server 402 receives the returned Web page and sends that Web information to travel scoring process 406. Travel scoring process 406 then takes the information and generates one or more potential itineraries using the values for factors input by the user. These factors are then analyzed using information from historical database 410 as well as flight information gathered from travel process 404. The final result is one or more travel itineraries, which may be returned to the user at client 420. From this list of itineraries, the user may select an itinerary from the choices provided from server 400. This authorization for this selection may be returned to server 400 and actual reservations made through travel process 404. Alternatively, the user may take the selected itinerary or itineraries along with a value assigned to the preferences and check for competitive bids or rates at other sites or travel agencies.

If the user desires to use existing preference, travel scoring process 406 will generate an itinerary using existing preference for the user or default preferences using preferences files 416. If an inference of preference is desired, inference engine 418 will generate the weighting of factors using information from user database 414 and preference files 416. As described above, historical user data in user database 414 may be analyzed to establish user weights for the user for different travel factors. Alternatively or in addition to the analysis, similar user preferences may be analyzed to establish these preference weights. These similar preferences may be identified by matching user characteristics or past travel behavior and ratings for users having similar travel patterns or destinations. Additionally, other demographic information may used to identify similar user preferences.

Turning now to FIG. 5, a diagram of a Web page is depicted in accordance with the preferred embodiment of the present invention. Web page 500 is an example of a Web page returned by server 400 in FIG. 4 for the user for assigning values to various factors. In this example, the factors include travel time 502, waiting time 504, plane changes 506, inconvenience of stops 508, aisle seat 510, window seat 512, and middle seat 514. Values for these various factors may be entered in fields 516-528. The selection of these factors as being ones that are important by the user may be selected through fields 530-546. This allows for the processes of the present invention to take into account factors unselected by the user. In other words, factors not selected by the user may be considered unimportant to the user. Such factors are of interest in identifying different travel itineraries. After the user has filled in values and made selections for one or more factors, the form may be selected by pressing submit form button 530. If the user desires to start over and has made mistakes, the user may clear the form by selecting clear form button 532. Web page 500 also includes home link 534 which will return the user to the home page for the site. Terms of use link 536 will provide the user with the terms for the particular service being provided by the Web site. Back link 538 will return the user to the previous page. Through Web page 500, user preferences with respect to different factors are obtained for use in identifying and scoring the value of different travel itineraries.

The factors illustrated in Web page 500 are only for purposes of illustration. Other factors also may be used in addition to or in place of those shown in Web page 500. Examples of other factors include: probability of a delay, probability of a cancellation, seating availability, availability of special meals, whether the route is a direct route, probability that a flight on the route will be full, expected wait time for baggage, amount of frequent flier miles, layover times, a safety record for a plane assigned to the route, a safety record of an airline for the route, and whether the route meets a selected set of travel guidelines.

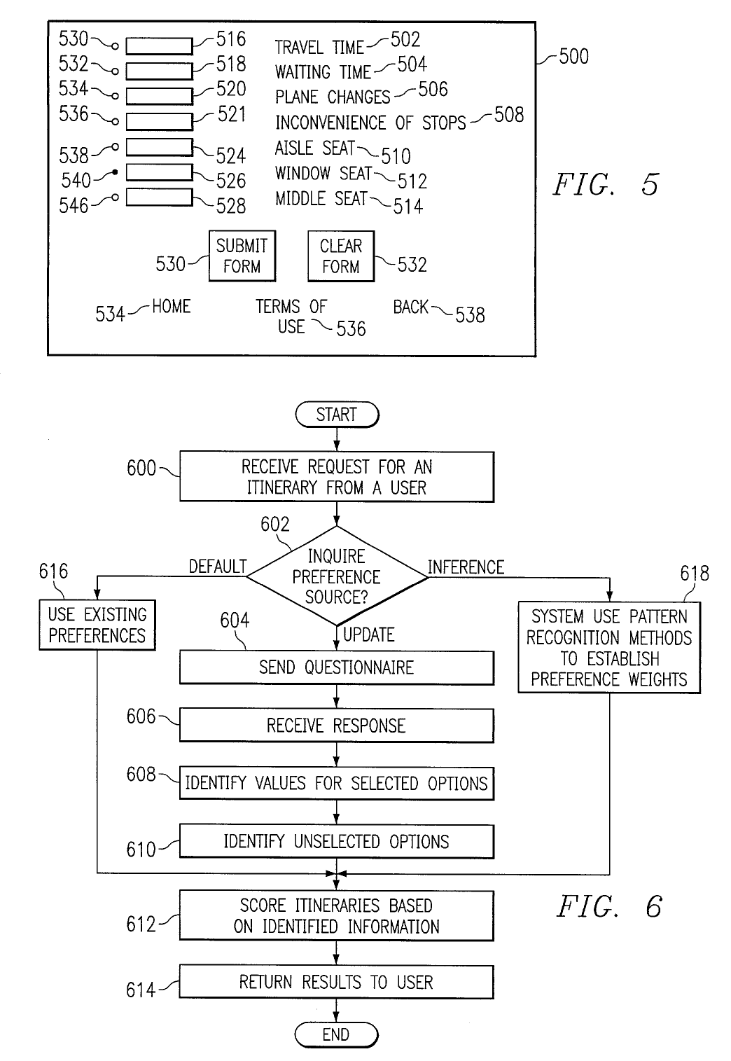

Turning now to FIG. 6, a flowchart of a process for generating itineraries is depicted in accordance with a preferred embodiment of the present invention. This process may be implemented in a server, such as server 104 in FIG. 1.

The process begins by receiving a request for an itinerary from a user (step 600). In this example, such a request may be received in server 400 in FIG. 4 using Web server 402. In response to the user's request, a preference source inquiry is made (step 602). This inquiry requests user input as to what source is to be used in identifying user preferences. If an update is the user preference, then a questionnaire is sent in the form of a Web page (step 604). A response to the questionnaire is received (step 606). In these examples, the questionnaire requests user preferences with respect to different factors. Additionally, negative confirmations may be part of the questionnaire or an inquiry in which a default preference is used unless the user changes or specifies a different preference. Then, values for selected options in the response are identified (step 608). Additionally, unselected options also are identified in the response (step 610). These unselected options may be useful in identifying what factors are of little or no value to a particular user.

Then, itineraries based on the identified information are scored (step 612). In scoring itineraries, the different values obtained from selected options and the identification of unselected options are used in comparing potential itineraries for the trip requested by the user. The results are returned to the user (step 614) with the process terminating thereafter.

With reference again to step 602, if the user preference is identified as a default, existing preferences are used (step 616) with the process moving to step 612 as described above. These existing preferences may be preferences previously selected by the user or a set of default preferences depending on the particular implementation.

However, if the user preference inquiry in step 602 is identified as an inference, the system will use pattern recognition methods to establish each preference weight (step 618) and the process moves to step 612 as described above. This pattern recognition may examine, for example, prior travel preference made by the user and/or user demographic information to identify probable preference for the user. The pattern recognition methods are implemented in an inference engine, such as inference engine 418 in FIG. 4.

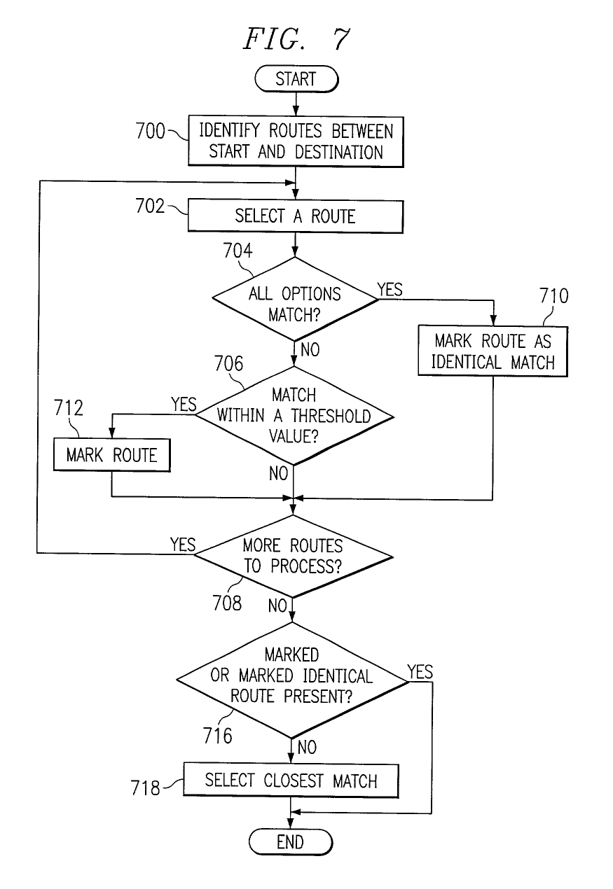

Turning now to FIG. 7, a flowchart of a process used for generating and scoring itineraries is depicted in accordance with the preferred embodiment of the present invention. This process is a more detailed description of step 610 in FIG. 6 and corresponds to the process implemented in travel scoring process 406 in FIG. 4. The process illustrated in FIG. 7 may generate a number of routes that either provide an exact match or fall within a threshold value that is considered acceptable to the user. These routes are then presented to the user as previously described.

The process begins by identifying routes between the origin and destination locations (step 700). Additionally, in step 700, alternative origin and destination locations may be selected for identifying routes based on the proximity of these alternative origin and destination locations to the one selected by the user. Such an alternative selection may depend on options selected by the user, such as whether alternative destinations or start locations are acceptable and the value of those locations.

Next, from the different routes selected, one route is selected for processing (step 702). A determination is made as to whether all of the options match the user selections and values assigned to those selections (step 704). A match may occur even if the actual value for a factor is greater than what is scored or assigned by the user. Values may be assigned to the factors using different scales. In these examples, a scale of 0 to 100 is used. For example, if the user assigned a value of 50 for avoiding a canceled flight and the actual value for this factor is 70, a small chance is present for a flight to be canceled. In such a case, this factor would still represent a match even though the user was not especially concerned about the possibility that the flight would be canceled. If all of the options do not match, then a determination is made as to whether a match between the route and the selected options are present within a threshold value (step 706).

Although an exact match between the options and values for factors selected by the user and the factors present in the route may not be present, values for different factors present in the route may be within a threshold value or some tolerance value that would be acceptable to the user. Such a threshold value may be a default value within the process or may be one selected by the user as part of the questionnaire. For example, a user may assign a value of 40 to a factor for avoiding delay in the flight and a value of 60 to the availability of special meals. If the likelihood of delay is greater in the particular route, but special meals are always available, these factors in the route may be assigned values of 30 and 60, respectively. The value of 30 for avoiding a delay means that avoiding delay is less likely than desired by the user. In such a case, an exact match is absent. If the value of 40 assigned by the user and the value of 30 as calculated by the likelihood of delay has a difference that is within a threshold value, then, the route may be deemed acceptable to the user although not a perfect match.

Numerous types of factors may be employed. In these examples, three types are used: (1) nominal scaled—such as labels (is O'Hare airport or is not); (2) ordinal scaled—such as ranking (seat 5 is closer to the front than seat 7 or 15 but the relative difference between the rows does not matter, just the order); and (3) cardinal or interval scaled—the relative values do matter, so that a route that is 500 miles is twice as good as a route that is 1000 miles.

For example, the user may assign values by inputting the values from a range of values, ranking an order of factors, or allocating a fixed number of points to the factors. In inputting values, the user may asked to assign a value from 1 to 10 for each factor. When allocating points to factors, a user may be given 100 points to assign to the different factors. Further, the user preferences for factors may be assigned using other techniques including inferring values based on user responses to questions or past behavior.

Preferences also may be obtained from an expert. Further, these preferences may be identified through a collective group assessment in which the group may be based on all available travelers or those having similarity to the particular user. Some factors may be inherent to a particular route, while others are note. Some factors may depend on comparisons with routes and with the user's criteria. The mechanism of the present invention assumes that more than one route is present to move a user from one location to another.

In matching or mapping between preferences and alternatives, two models are used in these examples, conjunctive models and compensatory models. First, conjunctive models (also referred to as elimination by aspect) evaluate alternatives one feature at a time with the order based on the users preferences. For example, if the most important feature in a route is the shortest distance, the profit process using this model will choose the route with the shortest distance. If several routes have the same distance, the process will select those routes, drop the others, and then evaluate the selected set on the next criteria. This process is repeated for each criteria until only one choice is left. If more than one choice remains after all the factors are evaluated, the routes are considered equal and one route may be chosen randomly.

Next, compensatory models allow different factors to compensate for one another. Although a user prefers American to USAir, the user is willing to accept a USAir flight if this flight is shorter and has a more reliable connection city. In contrast, with a conjunctive model, if “airline” is more important than “flight time”, the user will never consider the USAir flight if an American flight is present. Compensatory models are frequently implemented by assigning normalized scores to each factor among the available alternatives (in this case routes). Multiplying the user's preference ordering or weights with each factor generates a score for all the available routes. The highest scoring route is selected. If a tie is present, the choice may be made randomly.

If a match within a threshold value is absent, a determination is made as to whether more routes are present for processing (step 708). If more routes are present for processing, the process then returns to (step 702).

With reference again to step 704, if all the options match then the route is marked as an identical match (step 710). Thereafter, the process proceeds to step 708 as described above. Turning back to step 706, if a match is present within a threshold value, then the route is marked (step 712) with the process then proceeding to step 708 as described above.

If additional routes are not present for processing in step 708, then a determination is made as to whether a marked or a marked identical route is present from the routes processed (step 716). If such a route is absent, then a route having the closest match in values to the option selected by the user is selected for presentation (step 718) with the process terminating thereafter. Otherwise, the process also terminates.

Thus, the present invention provides an improved method, apparatus, and computer implemented instructions for generating routes and scoring them in response to user selections for various factors. This scoring system allows for an improved ability to select routes that will satisfy a user's preferences. The mechanism of the present invention takes into account various factors that may be of interest to a user, such as seating preferences, frequent flyer points for particular routes, whether plane changes are to be avoided, availability of special meals, and expected wait time for baggage as well as the possibilities of delays and cancellations. Based on the input by user, various routes may be compared and scored using those preferences to identify one or more routes that would meet the expectations of the user. Further, the scoring provided by the user and the identified routes may be used by the user to compare prices and desirability of traveling using other airlines or travel agencies. Further, the preferences collected by the mechanism of the present invention also allows an airline to identify factors that are desirable to travelers. With such information, both the traveler and the airlines have information available for selecting travel itineraries that are beneficial to both the user and the airlines.

The mechanism of the present invention may include artificial intelligence processes to include an ability for learning. Information on trips taken and not taken as well as which trips are considered good and bad may be used to better adjust selections for desired routes.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method on a data processing system for generating an itinerary, the method comprising:
identifying user values assigned to a set of factors relating to travel from a first location to a second location; and
comparing the user values to travel data for a route of travel from the first location to the second location to form a score.

2. The method of claim 1 further comprising:
comparing the user values to travel data for a set of routes of travel from the first location to the second location, wherein the set of routes includes the route; and
selecting a best route from the set of routes having a highest score when compared to the user values.

3. The method of claim 1, wherein the set of factors includes at least one of trip time for travel from the first location to the second location, probability of a delay, probability of a cancellation, seating availability, availability of special meal, whether the route is a direct route, probability that a flight on the route will be full, expected wait time for baggage, amount of frequent flier miles, layover times, nature of connection, a safety record for a plane assigned to the route, a safety record of an airline for the route, whether the route meets a selected set of travel guidelines.

4. The method of claim 1, wherein the set of factors includes a probability of a delay and wherein the comparing step includes:
comparing a specified time of travel for the route to travel data in the form of historical data to identify a probability of delay.

5. The method of claim 1, wherein the travel data includes historical data.

6. The method of claim 5, wherein the historical data includes delays associated with weather for times corresponding to a travel time for the route.

7. The method of claim 1, wherein the comparing step include:
performing statistical analysis of travel data for the route.

8. The method of claim 1, wherein the comparing step includes comparing factors absent in the user values.

9. The method of claim 1, wherein the route from the first location to the second location is one part of a route of travel from an origination to a final destination for a user.

10. The method of claim 2 further comprising:
sending a proposed itinerary to a user in response to selecting the best route.

11. The method of claim 10 further comprising:
reserving a seat on a flight for the best route in response to a user request to reserve the seat.

12. The method of claim 10, wherein the proposed itinerary includes a number of the set of routes.

13. A data processing system comprising:
a bus system;
a communications unit connected to the bus, wherein data is sent and received using the communications unit;
a display device connected to the bus system, wherein information is presented on the display device;
a memory connected to the bus system, wherein a set of instructions are located in the memory; and
a processor unit connected to the bus system, wherein the processor unit executes the set of instructions to identify user values assigned to a set of factors relating to travel from a first location to a second location; and compare the user values to travel data for a route of travel from the first location to the second location to form a score.

14. The data processing system of claim 13, wherein the bus system includes a primary bus and a secondary bus.

15. The data processing system of claim 13, wherein the processor unit includes a single processor.

16. The data processing system of claim 13, wherein the processor unit includes a plurality of processors.

17. The data processing system claim 13, wherein the communications unit provides a connection to at least one of a physical network and a wireless network.

18. The data processing system of claim 13, wherein the communications unit provides a connection to at least one of an Internet, an intranet, an extranet, a local area network, and a wide area network.

19. A data processing system for generating an itinerary, the data processing system comprising:
identifying means for identifying user values assigned to a set of factors relating to travel from a first location to a second location; and
comparing means for comparing the user values to travel data for a route of travel from the first location to the second location to form a score.

20. The data processing system of claim 19 further comprising:
comparing means for comparing the user values to travel data for a set of routes of travel from the first location to the second location, wherein the set of routes includes the route; and
selecting means for selecting a best route from the set of routes having a highest score when compared to the user values.

21. The data processing system of claim 19, wherein the set of factors includes at least one of trip time for travel from the first location to the second location, probability of a delay, probability of a cancellation, seating availability, availability of special meal, whether the route is a direct route, probability that a flight on the route will be full, expected wait time for baggage, amount of frequent flier miles, layover times, nature of connection, a safety record for a plane assigned to the route, a safety record of an airline for the route, whether the route meets a selected set of travel guidelines.

22. The data processing system of claim 19, wherein the set of factors includes a probability of a delay and wherein the comparing step includes:
comparing means for comparing a specified time of travel for the route to travel data in the form of historical data to identify a probability of delay.

23. The data processing system of claim 19, wherein the travel data includes historical data.

24. The data processing system of claim 23, wherein the historical data includes delays associated with weather for times corresponding to a travel time for the route.

25. The data processing system of claim 19, wherein the comparing step include:
performing means for performing statistical analysis of travel data for the route.

26. The data processing system of claim 19, wherein the comparing step includes comparing factors absent in the user values.

27. The data processing system of claim 19, wherein the route from the first location to the second location is one part of a route of travel from an origination to a final destination for a user.

28. The data processing system of claim 20 further comprising:
sending means for sending a proposed itinerary to a user in response to selecting the best route.

29. The data processing system of claim 28 further comprising:
reserving means for reserving a seat on a flight for the best route in response to a user request to reserve the seat.

30. The data processing system of claim 28, wherein the proposed itinerary includes a number of the set of routes.

31. A computer program product in a computer readable medium for generating an itinerary, the computer program product comprising:
first instructions for identifying user values assigned to a set of factors relating to travel from a first location to a second location; and
second instructions for comparing the user values to travel data for a route of travel from the first location to the second location to form a score.

32. The computer program product of claim 30 further comprising:
first instructions for comparing the user values to travel data for a set of routes of travel from the first location to the second location, wherein the set of routes includes the route; and
second instructions for selecting a best route from the set of routes having a highest score when compared to the user values.

33. The computer program product of claim 30, wherein the set of factors includes at least one of trip time for travel from the first location to the second location, probability of a delay, probability of a cancellation, seating availability, availability of special meal, whether the route is a direct route, probability that a flight on the route will be full, expected wait time for baggage, amount of frequent flier miles, layover times, a safety record for a plane assigned to the route, a safety record of an airline for the route, whether the route meets a selected set of travel guidelines.
